(19) United States
(12) Patent Application Publication
(10) Pub. No.: US 2025/0282074 A1
(43) Pub. Date: Sep. 11, 2025

(54) FOOD PROCESSOR WITH DICING GRID ACCESSORY AND CLEANING TOOL THEREFOR

(71) Applicant: Breville Pty Limited, Alexandria, New South Wales (AU)

(72) Inventors: Simon Peter MOORE, Alexandria, New South Wales (AU); Gerard Andrew WHITE, Alexandria, New South Wales (AU); Joshua Lyndon COOPER, Alexandria, New South Wales (AU)

(73) Assignee: Breville Pty Limited, Alexandria, New South Wales (AU)

(21) Appl. No.: 18/859,611

(22) PCT Filed: Apr. 27, 2023
(86) PCT No.: PCT/AU2023/050346

§ 371 Date: Oct. 24, 2024

(30) Foreign Application Priority Data
Apr. 27, 2022 (AU) 2022901110

(51) Int. Cl. B26D 7/18; B26D 3/18; B26D 11/00

(52) U.S. Cl. CPC B26D 7/1818; B26D 3/185; B26D 11/00

(57) ABSTRACT

A cleaning tool for cleaning a dicing grid accessory of a food processor, the dicing grid accessory having a dicing grid with a plurality of apertures, and an anchor hole located adjacent to the dicing grid, the cleaning tool having:
a body having a plurality of bosses dimensioned to be receivable by the plurality of apertures;
an anchor arm extending from the body, the anchor arm having a shape that conforms to the anchor hole of the dicing grid accessory and being releasably engageable with the anchor hole, such that, when the anchor arm is engaged with the anchor hole, the body is located with respect to the dicing grid and is pivotable about the anchor hole to allow the plurality of bosses to move into the plurality of apertures; and
a handle extending from the body opposite the anchor arm, such that, when the anchor arm is engaged with the anchor hole the handle provides leverage to increase the available force at the plurality of bosses as the bosses travel into the plurality of apertures.

### RELATED APPLICATIONS

This application claims convention priority from Australian Provisional Patent Application No. 2022901110, the contents of which are incorporated herein in their entirety by reference thereto.

### FIELD

This invention relates to food processor technology.

### BACKGROUND

Dicing grid accessories are becoming increasingly popular in the use of food processors, in order to process food items into diced food items quickly and efficiently. One issue plaguing dicing grids is that food items, particularly tough, starchy food items such as sweet potato, can become wedged, lodged, or otherwise stuck in the dicing grid and prevent use of the dicing grid. The dicing grid becomes inoperable either because the following food item being processed is softer and thus not able to dislodge the previous food item from the dicing grid, or because the dicing grid is blocked to such an extent that the force required to dislodge the food items from the dicing grid exceeds the permissible torque of the drive train.

Even smaller blockages are undesirable, as they lead to food items not being sliced cleanly, due to the backpressure imparted by the lodged food items in the dicing grid, and the slow pressing of food items through the dicing grid that offer resistance, rather than smooth slicing at higher velocities without the resistance.

### SUMMARY

It is an object of the present invention to at least substantially address one or more of the above disadvantages, or at least provide a useful alternative to the above approaches.

In a first aspect there is disclosed a cleaning tool for cleaning a dicing grid accessory of a food processor, the dicing grid accessory having a dicing grid with a plurality of apertures, and an anchor hole located adjacent to the dicing grid, the cleaning tool having:
a body having a plurality of bosses dimensioned to be receivable by the plurality of apertures;
an anchor arm extending from the body, the anchor arm having a shape that conforms to the anchor hole of the dicing grid accessory and being releasably engageable with the anchor hole, such that, when the anchor arm is engaged with the anchor hole, the body is located with respect to the dicing grid and is pivotable about the anchor hole to allow the plurality of bosses to move into the plurality of apertures; and
a handle extending from the body opposite the anchor arm, such that, when the anchor arm is engaged with the anchor hole the handle provides leverage to increase the available force at the plurality of bosses as the bosses travel into the plurality of apertures.

Preferably, the body includes a hinge on a surface opposite the plurality of bosses, and the handle is attached to the body through the hinge such that the handle is moveable between a rest position, wherein the handle extends from the hinge in a direction toward the anchor arm so as to reduce a total length of the cleaning tool, and an operational position, wherein the handle extends from the hinge in a direction opposite the anchor arm, and a storage position.

Preferably, each boss in the plurality of bosses is chamfered to allow the boss to engage the respective aperture at an angle while the cleaning tool is being pivoted to move the boss into the aperture.

Preferably, the anchor arm includes a hook to allow the anchor arm to engage the anchor hole.

In a second aspect there is disclosed a dicing grid accessory for a food processor to be cleaned by the cleaning tool of the first aspect, the dicing grid accessory having:
a dicing grid with a plurality of apertures; and
an anchor hole located adjacent to the dicing grid.

Preferably, the anchor hole includes a linear slot.

Preferably, the anchor hole includes two or more linear slots located along a common anchor direction.

Preferably, the dicing grid accessory includes an opening for receiving a drive shaft of the food processor, wherein the dicing grid is on a first side of the dicing grid accessory, and wherein the linear slot is on a second side of the dicing grid accessory along an anchor direction.

Preferably, the dicing grid accessory has a circular shape, with the opening in the center, and the anchor direction is a non-diametric chord of the dicing grid accessory.

In a third aspect, there is disclosed a food processor to process a food item into a diced food item, the food processor having:
a vessel having a floor, sidewalls extending upwardly from the floor to define a space for receiving the diced food item;
a blade mounted to the vessel so as to be rotatable about a drive axis the food item;
a drive shaft for driving the blade about the drive axis to slice the food item in a first direction; and
a dicing grid mounted to the vessel below the blade for sectioning the sliced food item to create the diced food item,
wherein the dicing grid includes a circular track and the blade includes at a perimeter thereof a cam that is engageable with the track such that a force path exists from the blade to the dicing grid.

Preferably, a bottom surface of the blade is non-parallel to the dicing grid to create a gap between a leading edge of the blade and the dicing grip, such that the sliced food item is urged into the dicing grid by the bottom surface of the blade as the blade is rotated by the drive shaft.

Preferably, the bottom surface of the blade has a helical shape.

Preferably, the blade has a leading edge that first engages the food item for slicing, wherein the leading edge has a negative angle of attack relative to a radius of the blade to reduce the force imparted from the food item on the blade as the blade slices the food item.

Preferably, the leading edge is continuously curved relative to the radius of the blade in a spiral shape such that the perimeter of the blade forms a single continuous leading edge.

Preferably, the spiral shape is a Fibonacci spiral.

Preferably, the blade includes a lift aperture to allow access for a finger of a user to lift the blade from the vessel.

Preferably, the lift aperture is located adjacent the drive shaft.

There is also disclosed, in combination, the cleaning tool of the first aspect and the dicing grid accessory of the second aspect.

### BRIEF DESCRIPTION OF THE DRAWING

Preferred embodiments of the present invention will now be described by way of example, with reference to the accompanying drawings, wherein:

FIG. 1 is an exploded perspective view of a food processor according to a preferred embodiment of the invention.

FIG. 2 is a perspective view of the food processor of FIG. 1.

FIG. 3 is a vertically sectioned side elevation view of the food processor of FIG. 1.

FIG. 4 is a detailed perspective view of a blade used with the food processor of FIG. 1.

FIG. 5 is a side elevation view of the blade of FIG. 4.

FIG. 6 is a top plan view of the blade of FIG. 4.

FIG. 7 is a detailed perspective view of the food processor of FIG. 1.

FIG. 8 is a vertically sectioned side elevation view of the food processor of FIG. 7.

FIG. 9 is a detailed perspective view of a dicing grid accessory used with the food processor of FIG. 1.

FIG. 10 is a top plan view of the dicing grid accessory of FIG. 9.

FIG. 11 is a detailed perspective view of a cleaning tool for the dicing grid accessory of FIG. 9.

FIG. 12 is a side elevation view of the cleaning tool of FIG. 11.

FIG. 13 is a perspective view of the cleaning tool of FIG. 11 used with the dicing grid accessory of FIG. 9 with a handle in a rest position.

FIG. 14A is a side elevation view of the cleaning tool and dicing grid accessory of FIG. 13 being pivoted to clean the dicing grid accessory.

FIG. 14B is a perspective view of the cleaning tool and dicing grid accessory of FIG. 13 being pivoted to clean the dicing grid accessory.

FIG. 15A is a side elevation view of the cleaning tool and dicing grid accessory of FIG. 13 being pivoted to clean the dicing grid accessory.

FIG. 15B is a perspective view of the cleaning tool and dicing grid accessory of FIG. 13 being pivoted to clean the dicing grid accessory.

FIG. 16A is a side elevation view of the cleaning tool and dicing grid accessory of FIG. 13 being pivoted to clean the dicing grid accessory.

FIG. 16B is a perspective view of the cleaning tool and dicing grid accessory of FIG. 13 having completed the cleaning operation.

### DETAILED DESCRIPTION

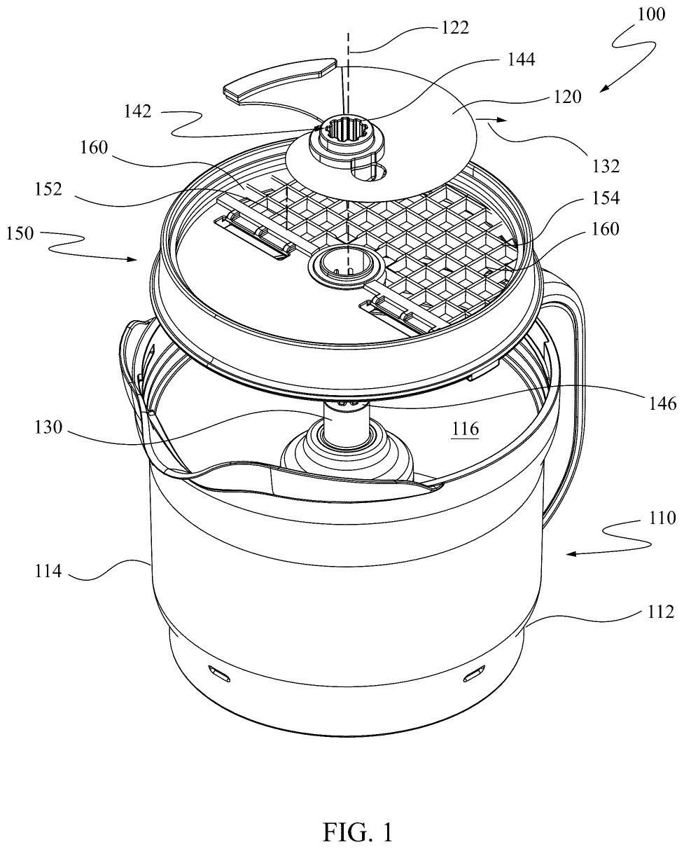

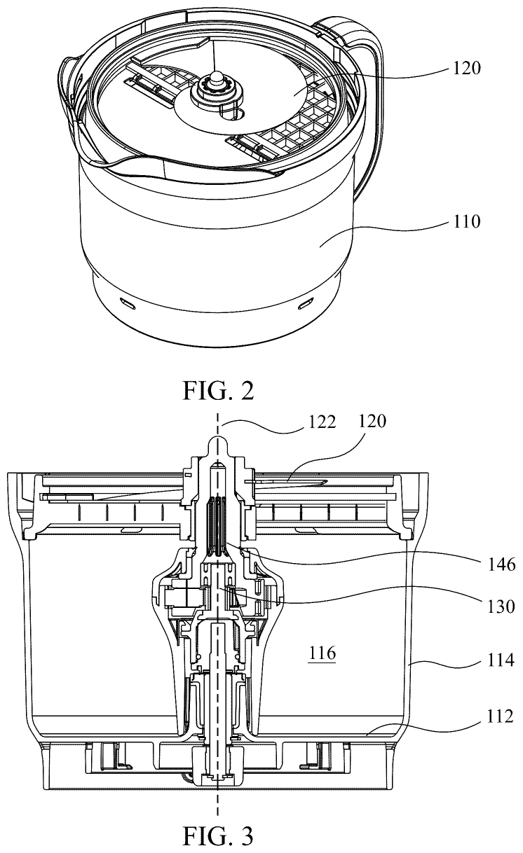

FIG. 1 shows a food processor 100 according to a preferred embodiment of the invention. Not shown in this embodiment are the drive unit consisting of motor, gearbox, and user interface, or the lid, chute, or food pusher, since these elements of food processors are well-known and do not form part of the inventive concepts disclosed herein.

The food processor 100 for processing a food item (not shown) into a diced food item (not shown) includes a vessel 110 having a floor 112 and one or more sidewalls 114 extending upwardly from the floor to define a space 116. The space 116 is typically sized to accommodate the diced food item. The food processor 100 further includes a blade 120 mounted to the vessel 110, as shown in FIG. 3, so as to be rotatable about a drive axis 122 to slice the food item. The food processor 100 further includes a drive shaft 130 for driving the blade 120 about the drive axis 122 in a first direction 132 to slice the food item. The blade 120 is connected to the drive shaft 130 by an opening 142 having a cammed profile 144 that matches a cammed profile 146 of the drive shaft 130.

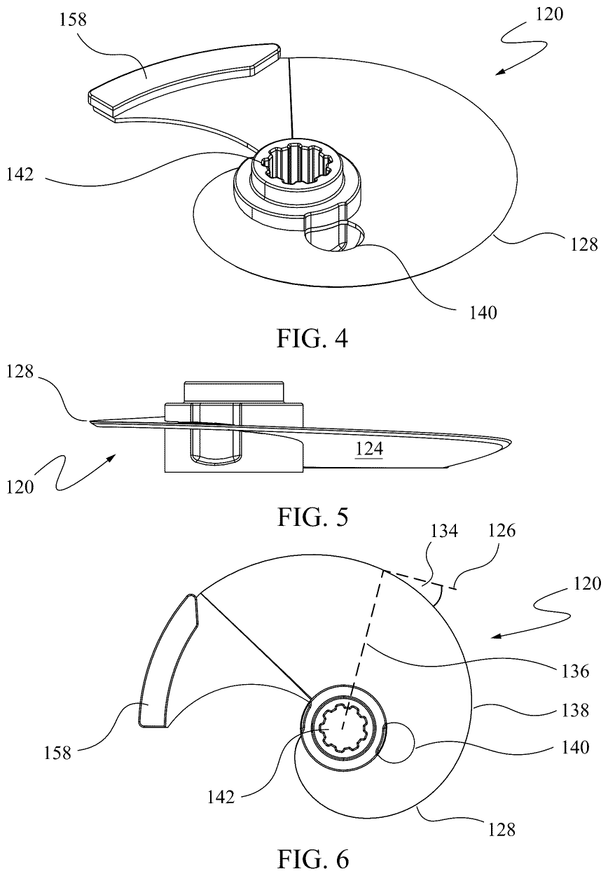

As shown in FIGS. 4 to 6, the blade 120 further has a leading edge 128, which is the part of the blade 120 that first comes into contact with the food item as the food item is being sliced by the blade 120 in the first direction 132 to create a sliced food item (not shown). The leading edge 128 preferably has a negative angle of attack 134 relative to an azimuthal direction 126, or tangent to the perimeter 138, of the blade 120 as the leading edge 128 engages the food item. Preferably, as best seen in FIG. 6, the leading edge 128 is continuously curved relative to a radius 136 of the blade 120 in a spiral shape, such that a perimeter 138 of the blade 120 forms a single continuous leading edge 128. Preferably, the spiral shape is a Fibonacci, or in a preferred embodiment a logarithmic, spiral.

The blade 120 further has a bottom surface 124 that slopes downwardly in the azimuthal direction 126. The downwardly sloping bottom surface 124 urges the food item, after it was sliced by the leading edge 128, downwardly due to the blade 120 being fixed to the drive shaft 130 and impingement of the food item against the bottom surface 124. Preferably, the bottom surface 124 has a helical shape as best seen in FIG. 5. Preferably, the blade 120 is of constant thickness and thin, such that the sloping of the bottom surface 124 is equivalent to the shape of the blade 120.

As best shown in FIG. 6, the blade 120 further includes a lift aperture 140 to allow access for a finger of a user (not shown) to lift the blade 120 from the drive shaft 130 and/or vessel 110. Preferably, as shown in FIG. 6, the lift aperture 140 is located adjacent to the opening 142 and preferably has a substantially circular shape.

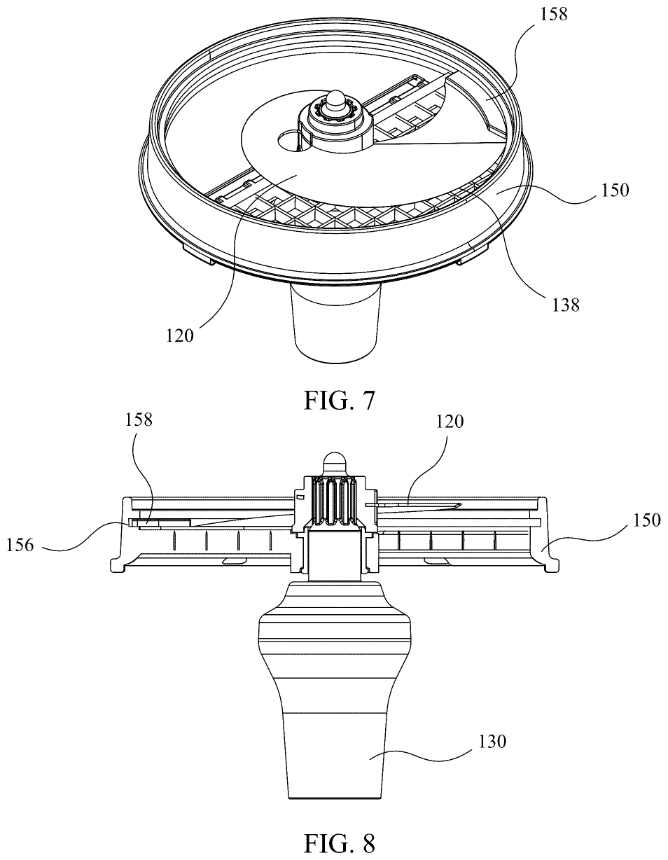

Returning briefly to FIG. 1, the food processor 100 further includes a dicing grid accessory 150 that is mounted to the vessel 110 below the blade 120. The dicing grid accessory 150 includes a dicing grid 154 having a plurality of apertures 160 for sectioning the sliced food item along a second direction 152 to create the diced food item. For example, the upper edges of the apertures 160 may be thin and/or sharpened. As shown in FIGS. 7 and 8, the dicing grid accessory 150 includes a circular track 156 that may be formed as a groove or simply as an inward protrusion. The blade 120 includes a cam 158 at the perimeter 138 of the blade 120. The cam 158 is engageable with the track 156 such that a force path exists from the blade 120 to the dicing grid accessory 150. Preferably, the cam 158 has a thickness that is larger than a thickness of the blade 120.

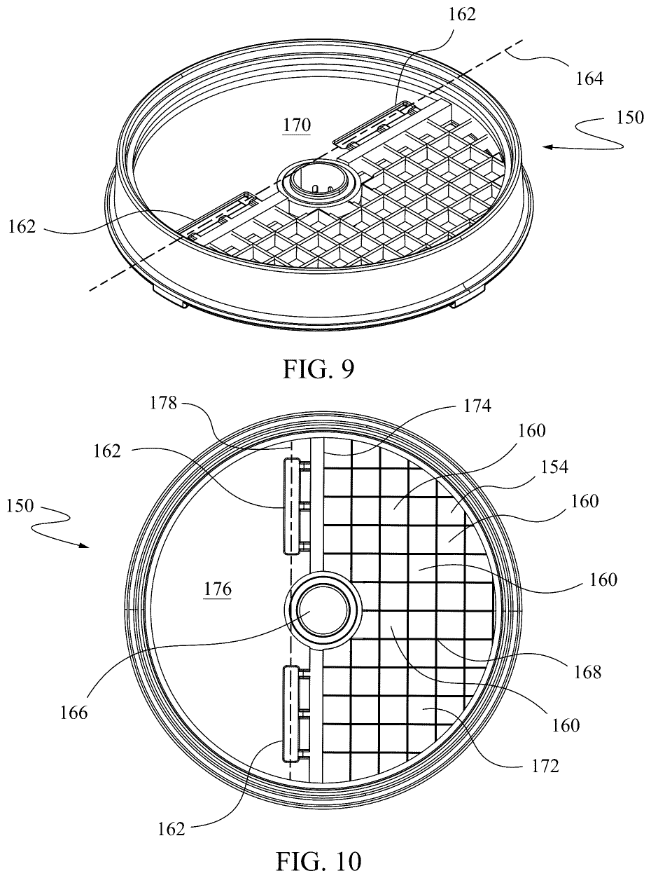

Moving now to FIGS. 9 and 10 to discuss the dicing grid accessory 150 in more detail. The dicing grid accessory includes an anchor hole 162 located adjacent to the dicing grid 154. Preferably, as shown in FIG. 10, the anchor hole includes a linear slot 162, more preferably two or more linear slots 162 located along a common anchor direction 164. The dicing grid accessory 150 further includes an opening 166 dimensioned to be larger than the cammed profile 144 of the drive shaft 130 so that the drive shaft 130 is allowed to rotate freely within the opening 166. Preferably, the dicing grid 154 only covers a portion 168 of a circular surface 170 of the preferably circular shaped dicing grid accessory 150, being a first side 172. In the embodiment shown in FIGS. 9 and 10, the portion 168 is defined by a first chord 174 that preferably intersects at least a portion of the opening 166. The linear slot 162 is located on a second side 176, being on an opposite side of the surface 170 than the first side 174. Preferably, the common anchor direction 164 is parallel to the first chord 174 and is located along a second chord 178 that is non-diametric, i.e., it does not intersect the center of the surface 170, and more preferably does not intersect the opening 166.

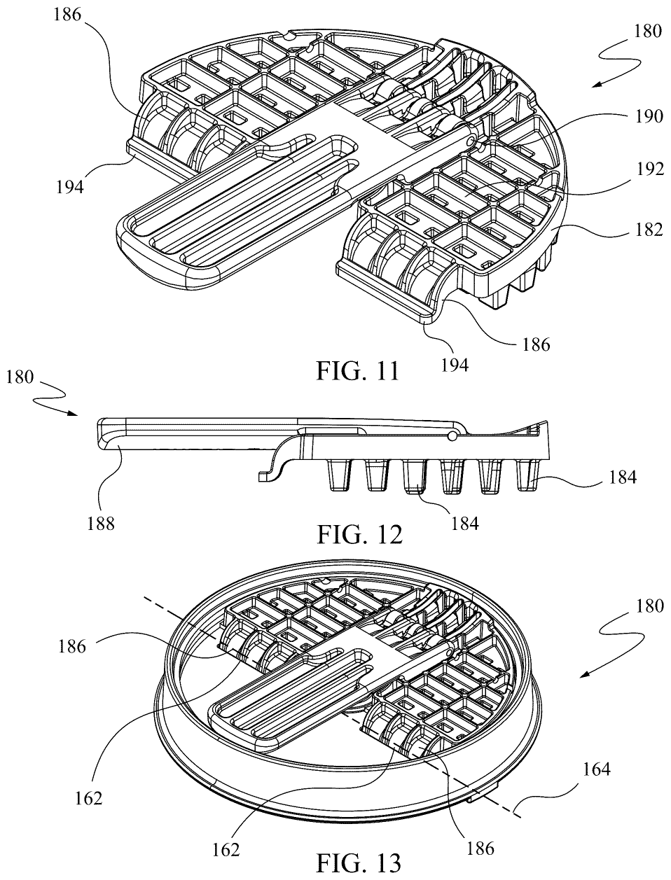

Moving now to FIGS. 11 to 13, which show a cleaning tool 180 for cleaning the dicing grid accessory 150 of the food processor 100. The cleaning tool includes a flat body 182 having a plurality of bosses 184 or teeth dimensioned to be receivable by the plurality of aperture 160.

The cleaning tool 180 further includes an anchor arm 186 extending from the flat body 182 and having a shape that conforms to the anchor hole 162 of the dicing grid accessory 150.

The anchor arm 186 is realeasably engageable with the anchor hole 162, for example by inclusion of a hook 194 to allow the anchor arm 186 to engage the anchor hole 162 and then bear against the surface 170 of the dicing grid accessory 150 to resist torque applied to the cleaning tool 180. The anchor arm 186 and anchor hole 162 are further situated such that, when the arm 186 is engaged with the hole 162, the flat body 182 is located with respect to the dicing grid 154 and is pivotable about the anchor hole 162 to allow the bosses 184 to move into the apertures 160. Thus, when the arm 186 is engaged with the hole 162, the cleaning tool 180 has a single degree of freedom with respect to the dicing grid accessory 150, the single degree of freedom being hinging about the anchor hole 162 or common anchor direction 164.

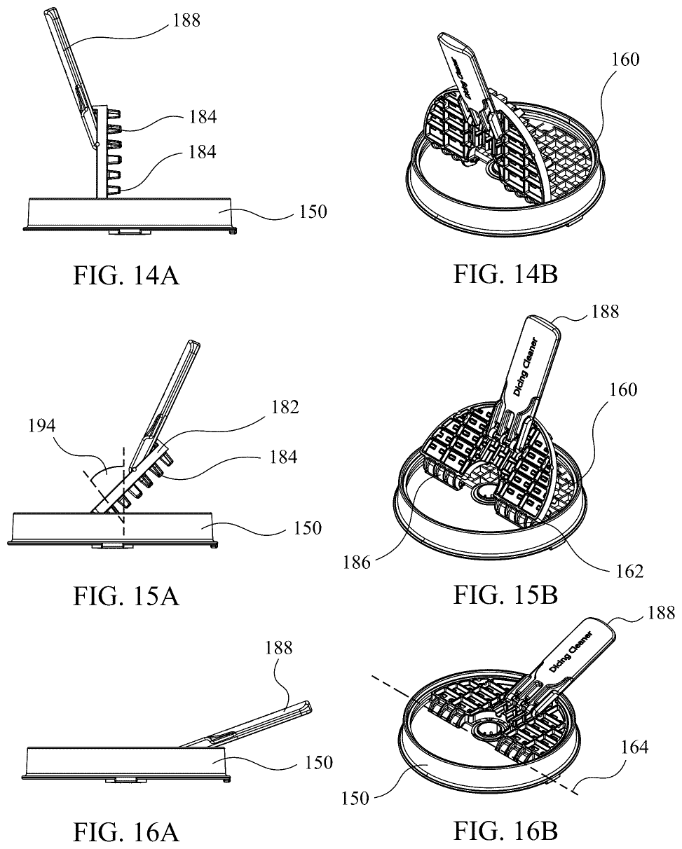

The cleaning tool 180 further includes a handle 188 extending from the flat body 182 opposite the anchor arm 186, as shown in FIG. 16A. Thus, when the anchor arm 186 is engaged with the anchor hole 162, the handle 188 provides leverage in the hinging motion about the common anchor direction 164 to increase the available force at the bosses 184 as the bosses 184 travel into the plurality of apertures 160. Returning to FIG. 11, the flat body 182 preferably includes a hinge 190 on a top surface 192 opposite the bosses 184. The handle 188 is attached to the flat body 182 using the hinge 190 such that the handle 188 is movable about the hinge 190 between a rest position, shown in FIGS. 11 to 13, and an operational position, shown in FIGS. 14A to 16B. In an alternative embodiment, the handle 188 can be removably attached via a ball and socket joint (not shown). In the rest position, the handle 188 extends from the hinge in a direction toward the anchor arm 186, while in the operational position the handle 188 extends from the hinge in a direction away from the anchor arm 186.

As shown in FIG. 12, each boss 184 in the plurality of bosses 184 is preferably chamfered, or angled, or rounded, to allow the boss 184 to engage the respective aperture 160 at an angle 194, shown in FIG. 15A, while the cleaning tool 180 is being pivoted to move the boss 184 into the aperture 160.

Use of the food processor 100, blade 120, and cleaning tool 180 will now be discussed.

To use the food processor 100 with the dicing grid accessory 150, the dicing grid accessory 150 is mounted on the vessel 110 such that the drive shaft 130 protrudes through the opening 166 in the dicing grid. The blade 120 is then mounted on the drive shaft 130 such that the cammed profiles 144, 146 engage to allow the transmission of torque from the drive shaft 130 to the blade 120. The cam 158 of the blade 120 is inserted into the track 156 by flexing the blade 120 temporarily, allowing the cam 158 to be inserted into the track 156. The food item may now be processed into a diced food item.

The food item is introduced to the food processor 100, typically using a chute or similar feed mechanism (not shown). The food item is engaged by the leading edge 128 of the blade 120. If the food item is tough to slice, the angle of attack 134 of the leading edge 128 allows the blade 120 to keep rotating while progressively slicing the food item. Once the food item has been sliced, the blade 120 rotates over the food item and keeps rotating. The downwardly sloping bottom surface 124 of the blade thus urges the food item into the dicing grid 154. Preferably, the food item is at least partially engaged by the dicing grid 154, such that the food item does not move substantially in response to the rotation of the blade 120, but is restricted to moving downwards into the dicing grid 154 under the urging of the blade 120. The dicing grid 154 sections the sliced food item to produce the diced food item, which subsequently collects in the vessel 110.

Should the dicing grid 154 become blocked, or a food item having a different hardness or consistency to a previous food item is to be processed, the dicing grid 154 may be cleaned using the cleaning tool 180. To do so, the blade 120 is removed from the drive shaft 130, and the cleaning tool 180 is engaged to the dicing grid by inserting the anchor arms 186 into the anchor holes 162, using the hooks 194. This restricts movement of the cleaning tool 180 relative to the dicing grid 154 to hinging of the cleaning tool about the common anchor direction 164. Preferably, the handle 188 of the cleaning tool 180 is moved to the operational position as seen in FIG. 14A. The insertion of the anchor arms 186 into the anchor holes 162 is also easier if the handle is in the operational position before engaging the arms 186 into the holes 162.

The cleaning tool 180 is then hinged about the common anchor direction 164 as seen in FIGS. 14A to 16B. The progressive engagement of apertures 160 by bosses 184 in a row-by-row fashion enabled by the hinging motion about the common anchor direction 164 maximises the force applied to the blockage in each aperture 160 from the torque applied to the handle 188, compared to, for example, a cleaning tool that approaches the apertures 160 linearly from above.

For storage of the food processor 100, the handle 188 is returned to the rest position and may be stored with the dicing grid accessory 150, as shown in FIG. 13.

Advantages of the food processor 100, blade 120, and cleaning tool 180 will now be discussed.

The motion of the handle 188 between the rest position and the operational position allows the cleaning tool 180 to be stored with the dicing grid accessory 150, while increasing the available torque for cleaning of the apertures 160 when in the operational position.

The chamfering or rounding of the bosses 184 allows entry of the bosses 184 into the apertures 160 at an angle, decreasing the chances of the cleaning tool 180 jamming during use, and reducing the manufacturing tolerance requirements for production of the cleaning tool 180. The use of the anchor arms 186 and anchor holes 162 allows location of the cleaning tool 180 with respect to the dicing grid 154 to ensure that the bosses 184 reliably clean the apertures 160. The use of two linear slots 162 reduces the degrees of freedom available to the cleaning tool 180 and further increases reliability of its use with the dicing grid 154. The location of the anchor hole 162 on a side opposite the dicing grid 154 increases the amount of force produced on blockages in the apertures 160 for a given torque.

The use of the track 156 and cam 158 reduces flexing of the blade 120 and improves the blade's 120 ability to reliably slice the food item. The sloping of the bottom surface 124 improves throughput of the food processor 100 by urging the sliced food item through the dicing grid 154. The use of the negative angle of attack 134 along the leading edge 128 reduces the torque applied on the drive shaft 130 by the food item as it is sliced by the blade 120. The use of a single spiral shape, preferably a Fibonacci spiral, maximises the time the blade 120 has at its disposal for successfully slicing a food item until the food item is wedged between the blade 120 and the sidewalls 114 of the vessel 110, at which point the torque applied by the food item on the drive shaft 130 dramatically increases. The use of the Fibonacci spiral shape ensures that the angle of attack 134 between the blade 120 and the food item is constant as the food item is displaced along a radial 136 direction during the slicing action. The advantage of the blade 120 is that the food item is continuously sliced, thereby distributing and minimizing forces applied to the blade and the food item, as opposed to a straight blade (not shown). The use of the lift aperture 140 allows the blade 120 to be safely removed from the drive shaft 130. The location of the lift aperture 140 adjacent the opening 142 allows the drive shaft 130 to be used as a bracing point while lifting the blade 120.

1.-18. (canceled)

19. A food processor to process a food item into a diced food item, the food processor having:
a vessel having a floor, sidewalls extending upwardly from the floor to define a space for receiving the diced food item; a blade mounted to the vessel so as to be rotatable about a drive axis the food item;
a drive shaft for driving the blade about the drive axis to slice the food item in a first direction; and
a dicing grid mounted to the vessel below the blade for sectioning the sliced food item to create the diced food item,
wherein the dicing grid includes a circular track and the blade includes at a perimeter thereof a cam that is engageable with the track such that a force path exists from the blade to the dicing grid.

20. The food processor of claim 19, wherein a bottom surface of the blade is non-parallel to the dicing grid to create a gap between a leading edge of the blade and the dicing grip, such that the sliced food item is urged into the dicing grid by the bottom surface of the blade as the blade is rotated by the drive shaft.

21. The food processor of claim 20, wherein the bottom surface of the blade has a helical shape.

22. The food processor of claim 19, wherein the blade has a leading edge that first engages the food item for slicing, wherein the leading edge has a negative angle of attack relative to a radius of the blade to reduce the force imparted from the food item on the blade as the blade slices the food item.

23. The food processor of claim 22, wherein the leading edge is continuously curved relative to the radius of the blade in a spiral shape such that the perimeter of the blade forms a single continuous leading edge.

24. The food processor of claim 23, wherein the spiral shape is a Fibonacci spiral.

25. The food processor of claim 19, wherein the blade includes a lift aperture to allow access for a finger of a user to lift the blade from the vessel.

26. The food processor of claim 25, wherein the lift aperture is located adjacent the drive shaft.

27. In combination, the food processor of claim 19, and a cleaning tool for cleaning a dicing grid accessory of the food processor, the dicing grid accessory having a dicing grid with a plurality of apertures, and an anchor hole located adjacent to the dicing grid, the cleaning tool having:
a body having a plurality of bosses dimensioned to be receivable by the plurality of apertures;
an anchor arm extending from the body, the anchor arm having a shape that conforms to the anchor hole of the dicing grid accessory and being releasably engageable with the anchor hole, such that, when the anchor arm is engaged with the anchor hole, the body is located with respect to the dicing grid and is pivotable about the anchor hole to allow the plurality of bosses to move into the plurality of apertures; and
a handle extending from the body opposite the anchor arm, such that, when the anchor arm is engaged with the anchor hole the handle provides leverage to increase the available force at the plurality of bosses as the bosses travel into the plurality of apertures.

28. The cleaning tool of claim 27, wherein the body includes a hinge on a surface opposite the plurality of bosses, and the handle is attached to the body through the hinge such that the handle is moveable between a rest position, wherein the handle extends from the hinge in a direction toward the anchor arm so as to reduce a total length of the cleaning tool, and an operational position, wherein the handle extends from the hinge in a direction opposite the anchor arm, and a storage position.

29. The cleaning tool of claim 27, wherein each boss in the plurality of bosses is chamfered to allow the boss to engage the respective aperture at an angle while the cleaning tool is being pivoted to move the boss into the aperture.

30. The cleaning tool of claim 27, wherein the anchor arm includes a hook to allow the anchor arm to engage the anchor hole.

31. In combination, the food processor of claim 19, and a dicing grid accessory for the food processor to be cleaned by the cleaning tool of claim 27, the dicing grid accessory having:
a dicing grid with a plurality of apertures; and
an anchor hole located adjacent to the dicing grid.

32. The dicing grid accessory of claim 31, wherein the anchor hole includes a linear slot.

33. The dicing grid of claim 31, wherein the anchor hole includes two or more linear slots located along a common anchor direction.

34. The dicing grid accessory of claim 31, wherein the dicing grid accessory includes an opening for receiving a drive shaft of the food processor, wherein the dicing grid is on a first side of the dicing grid accessory, and wherein the linear slot is on a second side of the dicing grid accessory along an anchor direction.

35. The dicing grid of claim 34, wherein dicing grid accessory has a circular shape, with the opening in the center, and the anchor direction is a non-diametric chord of the dicing grid accessory.

36. In combination, the food processor of claim 19, the cleaning tool of claim 27, and the dicing grid accessory of claim 31.
